(19) United States
(12) Patent Application Publication
(10) Pub. No.: US 2007/0136705 A1
(43) Pub. Date: Jun. 14, 2007

(54) Timing analysis method and device

(75) Inventor: Toshikatsu Hosono, Kasugai (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/396,540

(22) Filed: Apr. 4, 2006

(30) Foreign Application Priority Data
Dec. 9, 2005 (JP) 2005-355953

(51) Int. Cl. G06F 17/50

(52) U.S. Cl. 716/6

(57) ABSTRACT

A timing analysis device for preventing the amount of data and the number of analysis operations from increasing in a statistical analysis, while improving the timing convergence in a path included in a net under relatively strict timing conditions. The timing analysis device performs a static timing analysis to extract a net under relatively strict timing conditions from the analysis result and generate a timing list. The device further performs delay distribution calculation for the extracted net to analyze the delay variation in each of one or more instances included in the net. The device retrieves the timing list and sets a unique delay variation for each instance to calculate a delay distribution. The device further performs a statistical timing analysis based on the calculated delay distribution.

### CROSS-REFERENCE TO RELATED APPLICATIONS

This application is based upon and claims the benefit of priority from the prior Japanese Patent Application No.2005-355953, filed on Dec. 9, 2005, the entire contents of which are incorporated herein by reference.

### BACKGROUND OF THE INVENTION

The present invention relates to a semiconductor integrated circuit, and more particularly, to a method and device for efficiently analyzing timing in a digital circuit.

In a development process for semiconductor integrated circuits, static timing analysis (STA) is performed to verify timings in digital circuits. The static timing analysis verifies the timing in a circuit based on delay times assigned to elements in the circuit. In addition to the static timing analysis, a statistical analysis technique has recently been introduced to analyze timings. For the timing verification employing this statistical analysis technique, there is a demand for improving timing convergence in a path (signal transmission path) included in a net under relatively strict timing conditions, or in a so-called critical path. There are also demands for reducing the amount of data handled in the analysis process and for reducing analysis operations.

Timing verification is performed to check and ensure the operation of a logic circuit. In the timing verification, as shown in FIG. 1, a step for calculating a delay value in each element of a logic circuit is performed (step 101). Subsequently, an accumulated delay value for a signal transmission path is calculated based on the obtained delay values, and a step for analyzing pulse widths at input terminals of a flipflop circuit (FF circuit), a memory, or the like is performed (static timing analysis (STA)) (step 102). Further, a step for executing circuit correction is performed in accordance with a timing report generated based on the result of the static timing analysis (engineering change order (ECO)) (step 103).

In a semiconductor integrated circuit, the delay time is affected by variation in various factors such as the process for forming transistors and wirings, the power supply voltage, and the temperature. Therefore, the calculation of delay values is performed by using a coefficient indicating variation of respective factors on a chip, or on-chip variation (OCV). The static timing analysis using such an OCV coefficient enables circuit operations to be verified with the on-chip variation taken into account.

In the analysis method described above, however, variation in delays of instances (circuits including one or more logic circuits) forming a path is accumulated in accordance with the transmission order of a signal. Therefore, the timing verification is performed under conditions that are rarely required in actual circuits, that is, under very strict conditions. This makes the timing error convergence difficult and prolongs the period required for design and development.

Japanese Laid-Open Patent Publication No. 2005-019524 describes a method for performing timing analysis by replacing variations for each factor with statistical probability values. In this method, the conditions under which the timing verification is performed are moderated, thereby improving the timing convergence.

### SUMMARY OF THE INVENTION

In the method of Japanese Laid-Open Patent Publication No. 2005-019524, characteristic distributions of elements in a circuit is extracted by employing a technique such as Monte Carlo analysis. However, this method does not take into account variation distributions caused by characteristics unique to the elements on the chip or by the locations of the elements on the chip. This may lower the accuracy of the timing analysis. Moreover, in the above method, the analysis becomes complicated as the amount of data handled in the analysis process increases. Therefore, the analysis requires an extremely long period of time. This prolongs the period required for the design and development of LSIs and increases the number of analysis operations.

The present invention provides a timing analysis method and device capable of reducing the amount of data and analysis operations used for statistical analysis, while improving the timing convergence in a critical path.

One aspect of the present invention is a method for analyzing timing of a signal transmitted through a path including one or more instances in a net with the use of a computer. The method includes calculating a delay value for each of the instances, performing a static timing analysis based on the delay value, calculating a delay distribution for each of the instances based on the analysis result of the static timing analysis, and performing a statistical timing analysis based on the analysis result and the delay distribution.

A further aspect of the present invention is a device for analyzing the timing of a signal transmitted through a path including one or more instances in a net. A delay calculation unit calculates a delay value for each of the instances. A first analysis unit performs a static timing analysis based on the delay value. A delay distribution calculation unit calculates a delay distribution for each of the instances based on the analysis result of the static timing analysis. A second analysis unit performs a statistical timing analysis based on the analysis result and the delay distribution.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic flowchart showing timing analysis in the prior art;

FIG. 2 is a schematic flowchart showing timing analysis according to a preferred embodiment of the present invention;

FIG. 3 is a conceptual diagram of data generated by the timing list generation of FIG. 2;

FIG. 4 is a conceptual diagram of data generated by the statistical static timing analysis of FIG. 2;

FIG. 5 is a schematic block diagram showing a timing analysis device according to a preferred embodiment of the present invention;

FIG. 6 is a graph showing distributions of process variations and on-chip variations;

FIG. 7 is a schematic diagram showing a net under relatively strict timing conditions used for the analysis in the delay distribution calculation of FIG. 2;

FIG. 8 is a graph showing an on-chip delay variation range in a clock path and a data path in the net of FIG. 7;

FIG. 9 is a table showing an on-chip variation value under the worst conditions and the best conditions for PTV (process, temperature, and voltage);

FIGS. 10(a) to 10(d) are diagrams showing the distribution parameter extraction of FIG. 2, FIG. 10(a) is a schematic block diagram of a cell, FIG. 10(b) is a conceptual diagram of delay variations, FIG. 10(c) is a graph showing Gaussian distribution (normal distribution), and FIG. 10(d) is a graph showing the relationship between the load capacitance and the delay deviation which vary in accordance with the slew rate;

FIG. 11 is a detailed flowchart showing the delay distribution calculation of FIG. 2; and

FIG. 12 is a schematic diagram showing distribution of delay probabilities in a plurality of instances in the net of FIG. 7.

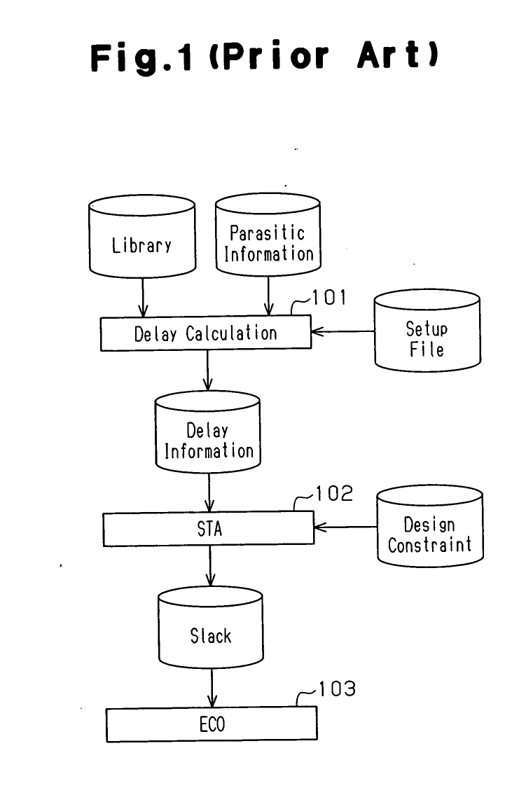

### DETAILED DESCRIPTION OF THE PREFERRED EMBODIMENTS

In the drawings, like numerals are used for like elements throughout.

A timing analysis method according to a preferred embodiment of the present invention will now be discussed with reference to the drawings.

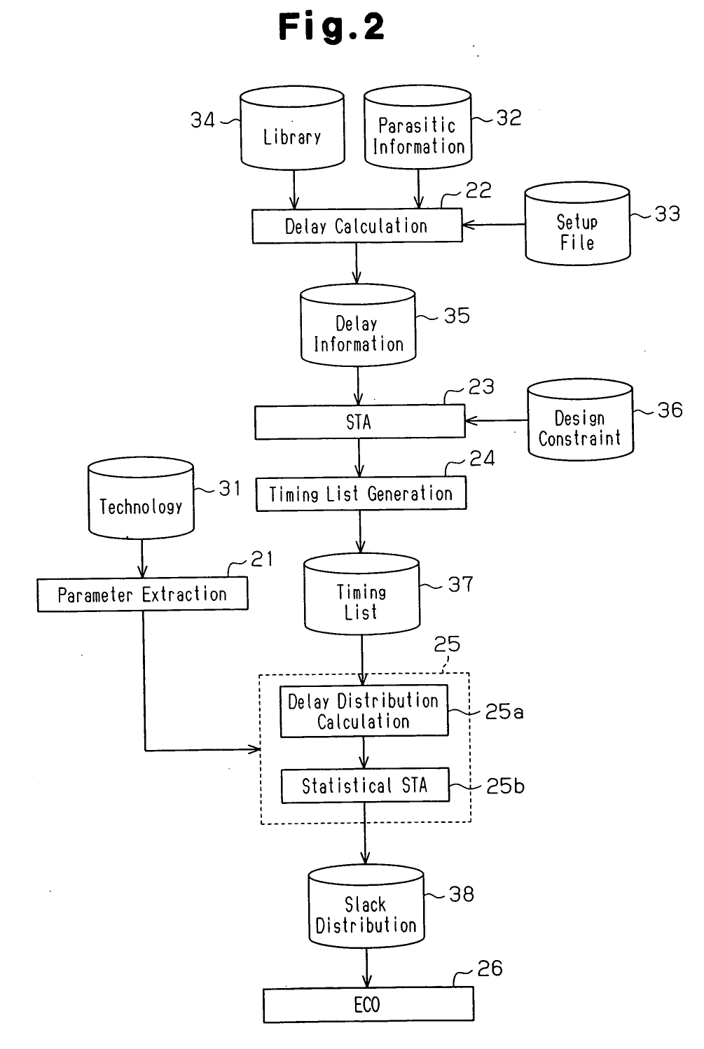

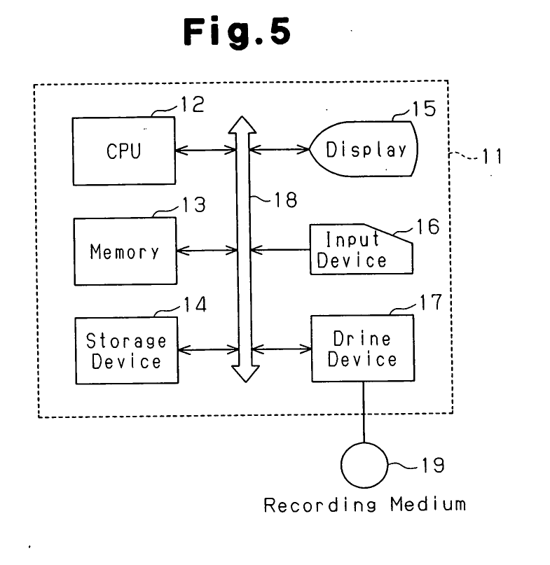

FIG. 2 is a flowchart illustrating timing analysis performed by a timing analysis device 11 shown in FIG. 5.

In step 21, the timing analysis device 11 simulates and analyzes delay time characteristics for each cell and each path based on a technology file 31. The timing analysis device 11 then generates a distribution parameter table using input slew rate and output load capacitance of each cell as parameters so that the table indicates distribution of the delay variation amount (standard deviation) in accordance with these parameters. The technology file 31 contains system correction coefficients and variation characteristic values of delay time at the rising edge and falling edge of an output signal from each cell in a standard process. The system correction coefficients include a coefficient depending on the density of cells arranged in the chip and a coefficient depending on the relative distance between cells. The table parameters further include the input capacitance, the leakage current, and the internal power and so on, which are in according with the input slew rate and output load capacitance of each cell. These parameters are set for each path and for each rising edge and falling edge of signals output from the cells.

Subsequently, in step 22, the timing analysis device 11 calculates a delay value for each cell in a subject path based on a parasitic information file 32, a setup file 33, and a cell library 34 to generate a file 35 containing delay information. The parasitic information file 32 contains parasitic information such as wiring parasitic capacitance. The setup file 33 contains margin information related to on-chip variation (OCV).

In step 23, the timing analysis device 11 executes timing analysis based on the file 35, containing delay information, and a file 36, containing design constraints.

Subsequently, in step 24, the timing analysis device 11 extracts a net corresponding to predetermined conditions based on the analysis result of step 23 and generates a timing list 37 of the extracted net. The timing list 37 includes information for the net under relatively strict timing conditions. The net under relatively strict timing conditions includes the so-called critical path, such as paths violating timings (violation paths) and paths having low operational margins (timing margins). The operational margin is determined, for example, by a cycle time. For example, a path having an operational margin corresponding to less than 10 percent of the cycle time is defined as a path having a low operational margin.

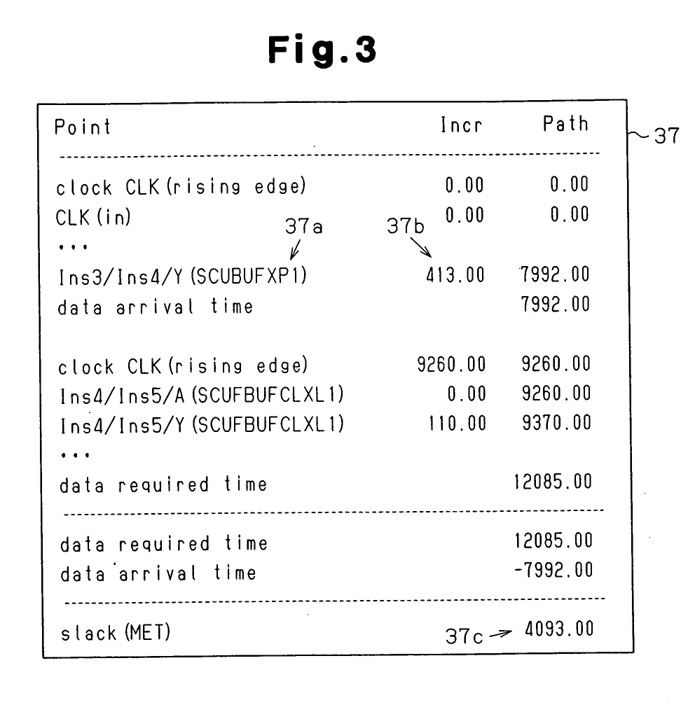

FIG. 3 is a conceptual diagram showing an example of data stored in the timing list 37. The timing list 37 includes the instance name 37a (e.g., SCUBUFFXP1), delay information 37b for the instance (e.g., 413.00), and slack value 37c indicating the timing analysis result (e.g., 4093.00). The slack value 37c indicates the timing margin of the path. When the slack value 37c is zero, this indicates that the path in the list is a critical path. When the slack value 37c is a negative value, this indicates that the path in the list is a violation path. Accordingly, information for the net under relatively strict timing conditions is obtained from the slack value 37c.

Subsequently, in step 25, the timing analysis device 11 executes a delay distribution calculation (step 25a) and a statistical timing analysis (statistical static timing analysis (SSTA)) (step 25b).

In step 25a, the timing analysis device 11 retrieves the timing list 37 and calculates a delay distribution for each instance included in the net under relatively strict timing conditions.

More particularly, the timing analysis device 11 refers to the distribution parameters for the individual cells (instances) generated in step 21 to extract delay distributions for the instances corresponding to the input slew rate and the output load capacitance, both of which are set as unique circuit parameters. To analyze the distribution parameters resulting from the element characteristics, the timing analysis device 11 then sets unique delay variations for each instance in accordance with a coefficient of fluctuation caused by the chip layout, such as the location of each instance or the wiring density around each instance.

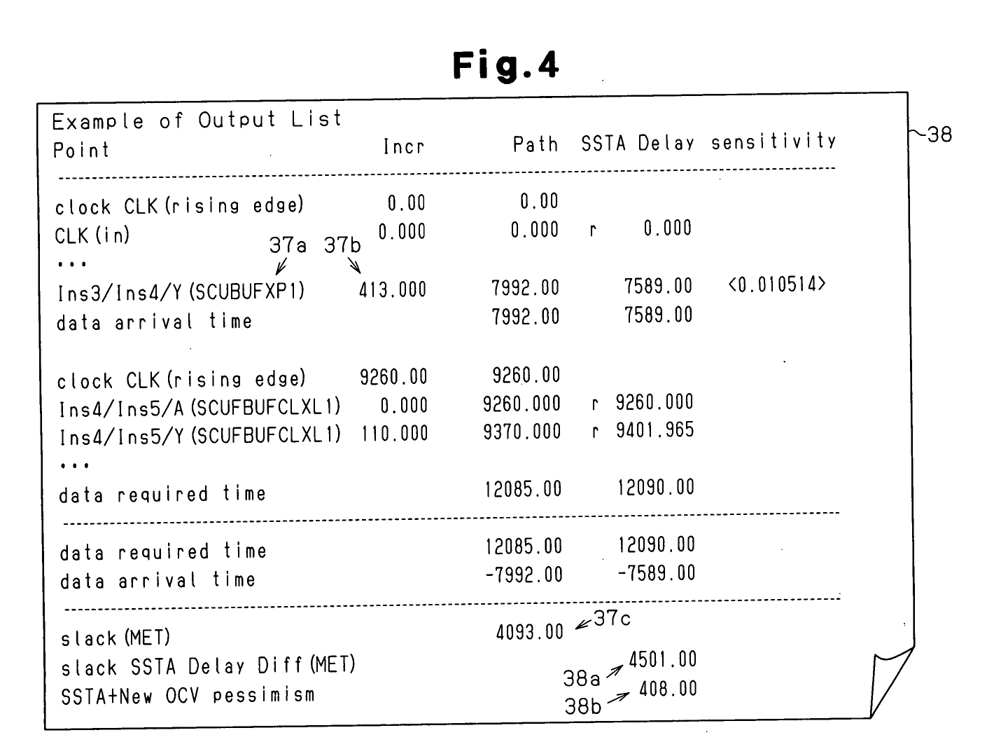

Subsequently, in step 25b, the timing analysis device 11 performs statistical timing analysis with the Monte Carlo analysis or approximation technique, based on the delay distribution obtained for each instance in step 25a. The timing analysis device 11 then generates a file 38 containing information indicating the analysis result. The file 38 contains information indicating sensitivity analysis results and distribution of slack values in the subject path. FIG. 4 shows an example of an output list indicating the analysis result. In FIG. 4, the value “4501.00” denoted by reference numeral 38a represents a slack value (margin amount) improved by the method of the present invention. The value “408.00” denoted by reference numeral 38b represents a condition moderation amount (4501.00-4093.00).

In step 26, the timing analysis device 11 executes corrections (ECO), such as change in wiring path (for example, change of layout in a cell or addition of a buffer to the path) for the net requiring correction, based on the file 38.

According to this embodiment, the circuit characteristics of each instance are taken into account by setting a unique variation for each instance. Additionally, the execution of the statistical timing analysis reduces the amount of data handled in the timing analysis. This makes it possible to perform analysis within an effective period (tolerable period for the analysis). Accordingly, the timing convergence in the critical path is improved.

Further, the accuracy of the statistical timing analysis is improved by taking into account the variations in each instance. Moreover, information required for the statistical timing analysis is extracted from the results of the conventional static timing analysis. This effectively utilizes existing systems.

FIG. 5 is a schematic diagram of the timing analysis device 11.

The timing analysis device 11 is formed by a typical computer-aided design (CAD) device. The timing analysis device 11 includes a central processing unit (hereafter, to be referred to as the “CPU”) 12, a memory 13, a storage device 14, a display 15, an input device 16, and a drive device 17, which are connected to one another by a bus 18. In the present embodiment, the CPU 12 functions as a delay calculation unit, a delay distribution calculation unit, a first analysis unit, a second analysis unit, and a list generation unit.

The CPU 12 executes a program utilizing the memory 13 to perform processing required for the timing analysis. The memory 13 stores programs and data required for providing the function of the timing analysis. The memory 13 may be a cache memory, a system memory, and a display memory (not shown).

The display 15 is used for displaying a layout, a parameter entry screen, or the like. The display 15 may be a CRT, an LCD, and a PDP (not shown). The input device 16 is used by the user to enter requests, instructions, and parameters. The input device 16 includes a keyboard and a mouse device (not shown).

The storage device 14 may normally be a magnetic disk device, an optical disc device, and a magneto-optical disc device (not shown). The storage device 14 stores program data (hereafter, referred to as the “programs”), which is used for the timing analysis shown in FIG. 2, the data files (hereafter, to be referred to as the “files”) 31 to 38, which are described above, and the distribution parameter table generated in step 21. The CPU 12 transfers the programs and the data stored in the files to the memory 13 in response to instructions given by the user through the input device 16, and sequentially executes the programs. The CPU 12 generates files and data by executing the programs and stores the generated files and data in the storage device 14. The storage device 14 is also used as a database.

The programs executed by the CPU 12 are provided from a recording medium 19. The drive device 17 drives the recording medium 19 to access the contents stored therein. The CPU 12 reads the programs from the recording medium 19 with the drive device 17 and installs the programs in the storage device 14.

The recording medium 19 may be any computer readable recording medium, such as a memory card, a flexible disk, an optical disc (CD-ROM, DVD-ROM, or the like), a magneto-optical disc (MO, MD, or the like) (not shown). The above-mentioned programs may be stored in the recording medium 19. In this case, the CPU 12 loads the programs from the recording medium 19 into the memory 13 when necessary.

The recording medium 19 includes a recording medium and a disc device in which a program is uploaded or downloaded via a communication medium. The recording medium 19 further includes a recording medium on which a program that is directly executable by a computer is recorded. The recording medium 19 further includes a recording medium recording a program that becomes executable when installed on another recording medium (e.g., a hard disk) or a recording medium on which an encrypted or compressed program is recorded.

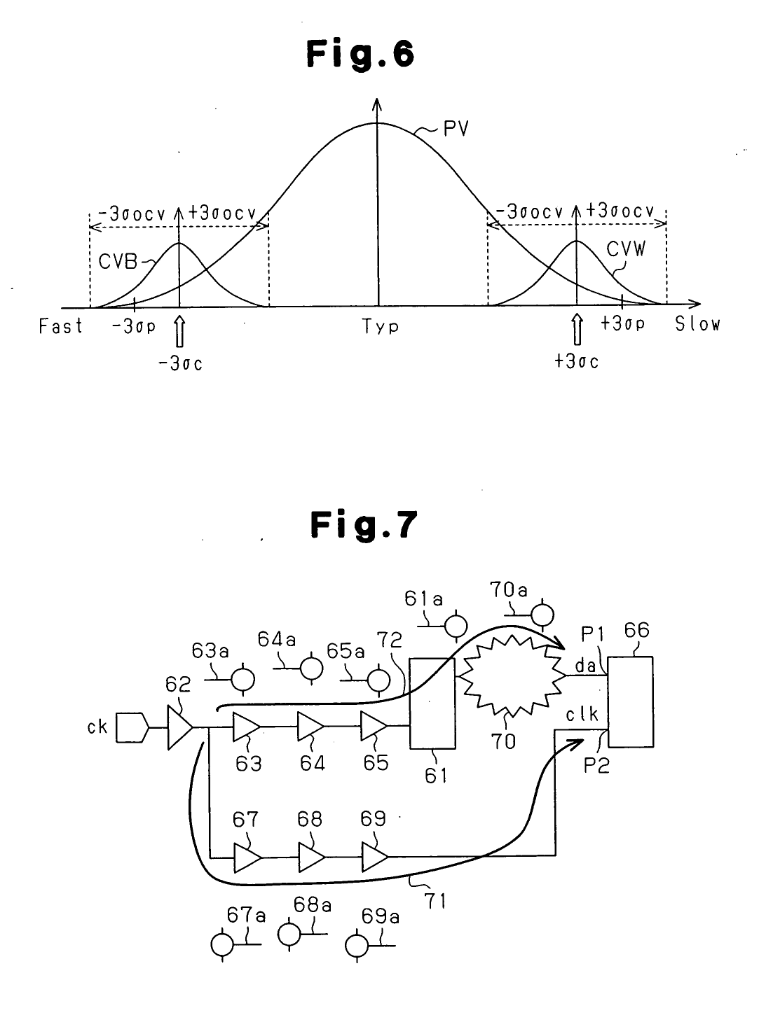

FIG. 6 is a schematic graph illustrating distributions of the process variation and the on-chip variation.

In FIG. 6, “PV” represents variation in the entire process, “CVW” represents on-chip variation under the worst conditions, and “CVB” represents on-chip variation under the best conditions. “Typ” represents a median value of the distribution in the entire process, “+3 σp” represents the worst value in the entire process, and “−3 σp” represents the best value in the entire process.

The range of the on-chip variation under the worst condition is expressed as ±3 σocv of which median value is +3 σc for the variations in the entire process. The range of the on-chip variation under the best conditions is expressed as ±3 σocv of which median value is −3 σc for the variation in the entire process.

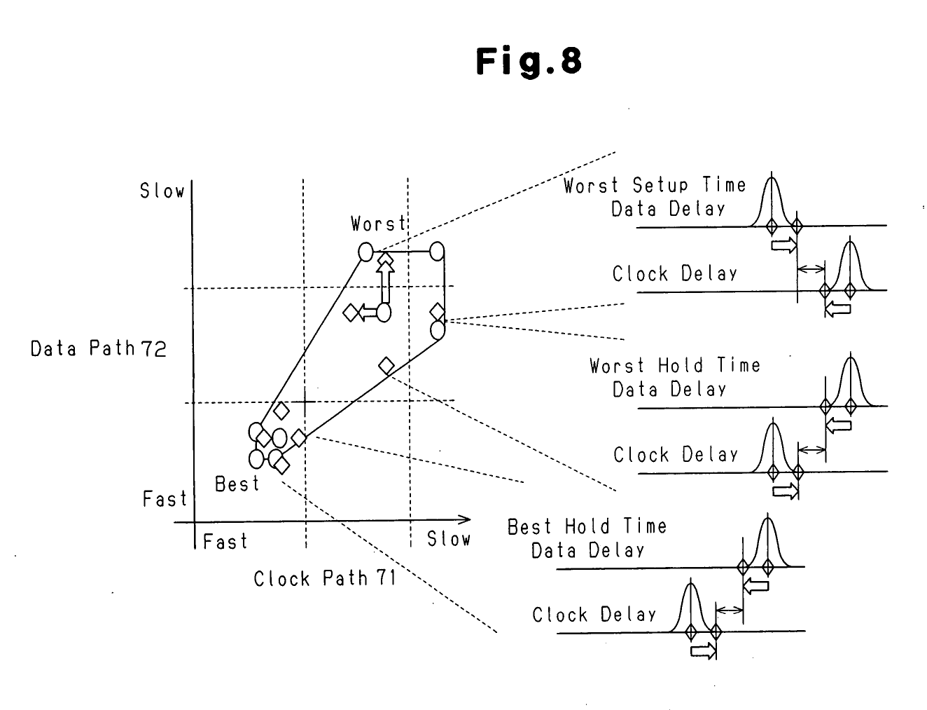

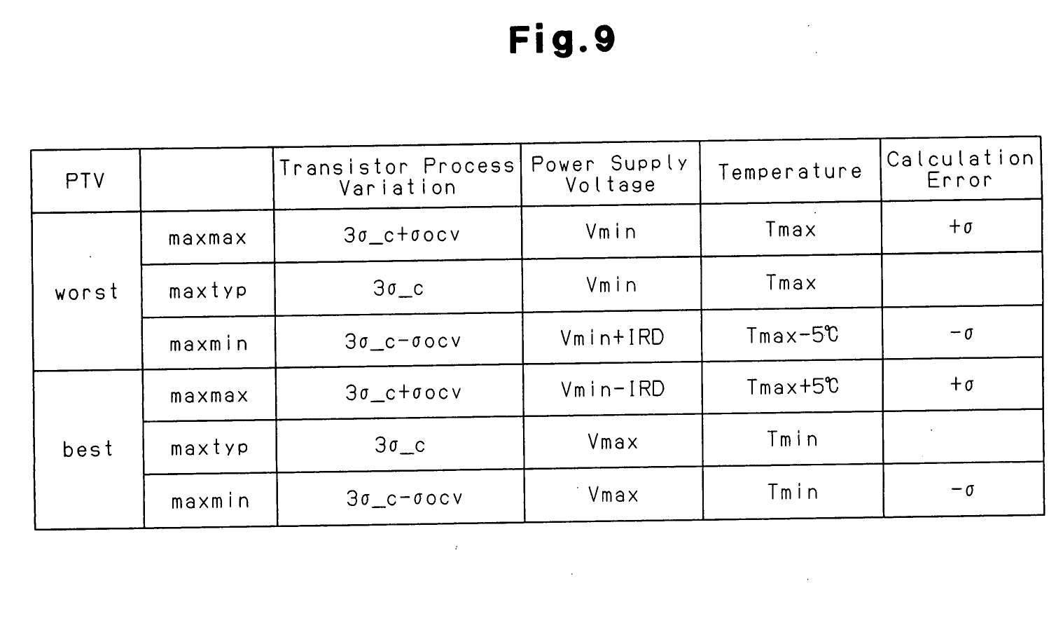

FIG. 8 is a schematic graph showing the range of the on-chip variations for a clock path 71 and a data path 72 of the net shown in FIG. 7. In the graph shown on the left side in FIG. 8, the range enclosed by the solid line indicates the range of timing margins for a clock and a data signal. A variation value corresponding to analysis conditions is set based on this range. The analysis conditions in the clock path 71 and the data path 72 include “worst setup time”, “worst hold time”, and “best hold time”, which are shown in FIG. 8, and “best setup time”, which is not shown in FIG. 8. In the analysis under the “worst setup time” condition, for example, the delay variation for the data signal is set to the worst value of the on-chip variation, and the delay variation of the clock is set to the best value of the on-chip variation. As a result, the timing analysis is carried out under strict margin conditions. The worst value and the best value are set with respect to the median value of variation in accordance with, for example, the various conditions shown in FIG. 9. FIG. 9 shows the variation values for transistor process variation, power supply voltage, temperature, and calculating error under the worst PTV (process, temperature, and voltage) conditions and the variation values under the best PTV conditions.

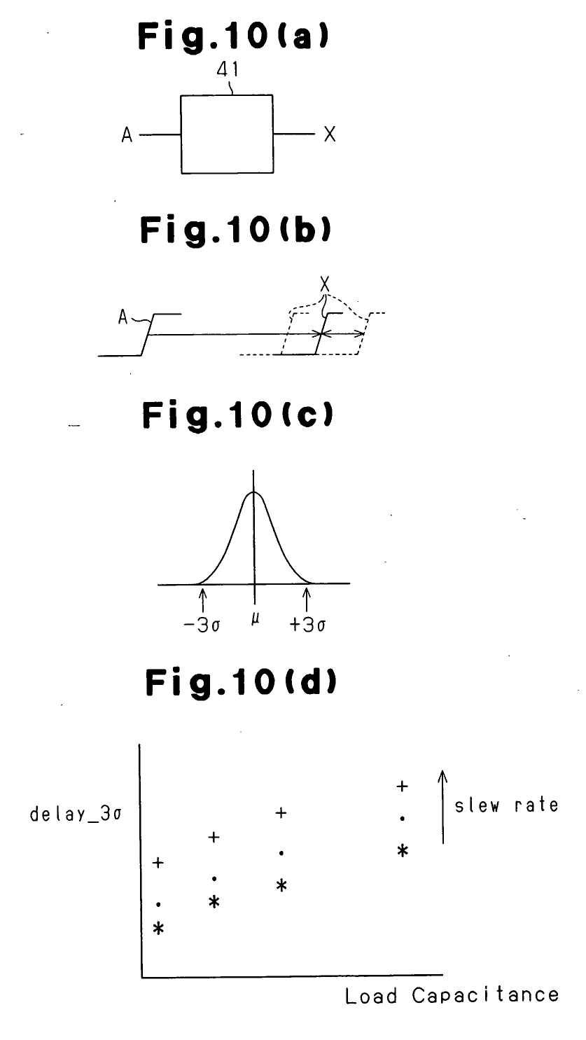

FIGS. 10(a) to 10(d) are diagrams for describing the distribution parameter extraction shown in FIG. 2.

As shown in FIG. 10(a), a cell 41 receives a signal A and outputs a signal X. In the cell 41, a delay time and delay variation exists between the received signal A and the output signal X as shown in FIG. 10(b). The broken line in FIG. 10(b) represents the delay of the signal X when a maximum variation occurs. In the cell 41, the variation caused by various conditions is in accordance with the Gaussian distribution (normal distribution) as shown in FIG. 10(c). Accordingly, the probability that the rising edge of the signal X exists in the range of 3a is 99.73%. FIG. 10(d) shows the delay distribution in the cell 41 that is tabulated by using four different load capacitance and three different slew rates as parameters. Although the four different load capacitance and the three different slew rates are used as parameters in FIG. 10(d), the numbers of different load capacitance and slew rates are not limited in such a manner.

A table as shown in FIG. 10(d) is prepared in correspondence with each of the different conditions (temperature conditions and voltage conditions). Specifically, when voltage fluctuation and temperature fluctuation are taken into account, table values corresponding to the conditions are obtained, and interpolation is performed based on the values before and after the conditional fluctuation. Voltage and temperature values corresponding to the conditional fluctuations are obtained through interpolation. The fluctuations may also be obtained by calculation using a scaling coefficient representing change in conditions with respect to standard conditions.

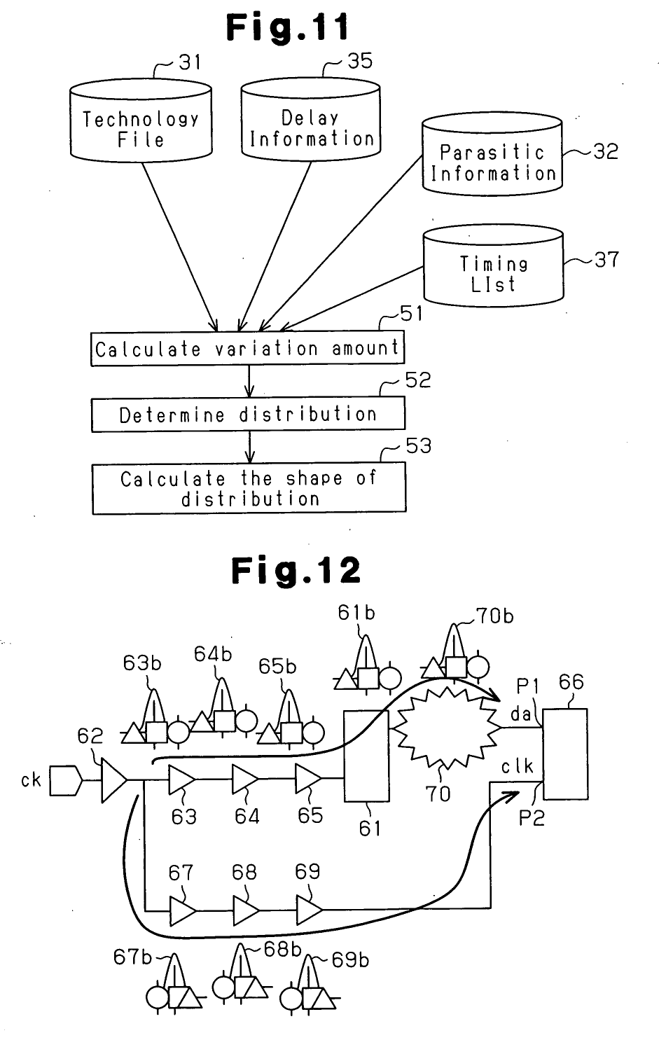

FIG. 11 is a flowchart showing details of the delay distribution calculation (step 25a) of FIG. 2. Step 25a of FIG. 2 includes steps 51 to 53.

In step 51, the timing analysis device 11 retrieves the technology file 31, the file 35 containing delay information, the file 32 containing parasitic information, and the timing list 37. The timing analysis device 11 collects unique parameters for each instance in the timing list 37 from the files 35 and 32. More specifically, the timing analysis device 11 collects slew rates, load capacitance, and correction coefficients from the file 35. The timing analysis device 11 also collects coordinate information and density information from the file 32.

Subsequently, in step 52, the timing analysis device 11 calculates a variation value (standard deviation) and a median value for each of the instances in the timing list 37 based on its unique parameter in accordance with the definition of the delay value. The standard deviation is extracted from the table generated in step 21 in accordance with the slew rate and the load capacitance. The timing analysis device 11 obtains a value under a desired voltage and temperature by interpolating values extracted from the tables based on the voltage conditions and temperature conditions in the tables. Additionally, the timing analysis device 11 may multiply the interpolated value by a system correction coefficient.

Subsequently, in step 53, the timing analysis device 11 calculates the shape of delay distribution for the instances in the timing list 37 as the delay values in accordance with the probability of occurrence of delays and stores the delay values in the storage device 14. Upon completion of calculation of the shape of delay distribution for all the cells, the timing analysis device 11 completes the delay distribution calculation.

FIG. 12 shows an example of a net under relatively strict timing conditions. The net has a path including buffer circuits 62 to 65, for transmitting a clock clk to a first flipflop circuit (hereafter, referred to as the “FF circuit”) 61, and a path including buffer circuits 62, and 67 to 69, for transmitting the clock clk to a second FF circuit 66. An output signal from the first FF circuit 61 is provided to the second FF circuit 66 through a synthesizing circuit 70. The buffer circuits 63 to 65, and 67 to 69, the first FF circuit 61, the second FF circuit 66, and the synthesizing circuit 70 are set as instances. In this net, the data signal da and the clock clk provided to the second FF circuit 66 have violating timings or low timing margins.

In this net, maximum delay values 63a to 65a, 61a, and 70a respectively corresponding to the buffer circuits 63 to 65, the first FF circuit 61, and the synthesizing circuit 70 forming a data path, and minimum delay values 67a to 69a respectively corresponding to the buffer circuits 67 to 69 forming a clock path are stored in the timing list 37. These delay values are obtained by multiplying the values obtained by the analysis of delays in the instances based on the values in the library by an OCV coefficient. Accordingly, when the values obtained by the delay analysis based on the values in the library are represented as the median values of the characteristics, the median values that are in accordance with the circuit conditions, that is, the standard deviation of the delay values is obtained by dividing the delay values stored in the timing list 37 by the OCV coefficient. The delay distributions in the instances according to the circuit conditions are obtained in this manner.

The standard deviation of the delay values is corrected in accordance with the conditions of the voltage variation and the temperature variation in the chip. As described above, the correction method includes a method using interpolation or a method using a scaling coefficient. If interpolation is performed, a plurality of tables that are in accordance with different voltage conditions and different temperature conditions are prepared in the library. The standard deviation is interpolated by using the values in the table corresponding to the conditions. When the library contains the tables for the standard deviation and the scaling coefficient, the standard deviation is corrected by multiplying the value extracted from the table for standard deviation by the scaling coefficient. If a coefficient depending on the density of the cells on the layout, or a coefficient depending on the relative distance between the cells, is extracted in the library, this coefficient is also taken into account.

FIG. 12 shows the data generated in steps 51 to 53 of FIG. 11, that is, information on the delay probability distributions 61b, 63b to 65b, 67b to 69b, and 70b in the instances (the buffer circuits 63 to 65, and 67 to 69, the first FF circuit 61, the second FF circuit 66, and the synthesizing circuit 70). In FIG. 12, a square represents a median value of probability distribution, a triangle represents a delay time that occurs at the probability of −3σ, and a circle represents a delay time that occurs at the probability of +3σ.

With reference to FIG. 12, a case in which the setup time is analyzed under the worst conditions will be described. Delay variations of signals provided to the terminals P1 and P2 of the second FF circuit 66 are first obtained. A data signal da is provided to the terminal P1, while a clock clk is provided to the terminal P2. For the analysis of the setup time, as shown in FIG. 8, the median value and the worst value of the delay distribution under the worst conditions are used for the data signal da, and the median value and the best value of the delay distribution under the worst conditions are used for the clock clk.

The median value of the delay distribution of the signal provided to the terminal P1 is typ_P1, the maximum delay value is max_P1, and the minimum delay value is min_P1. The delay value D is, for example, defined by the equation:
D=typ×Kocv
where “typ” represents the median value of delay distribution of a signal provided to the input terminal of an instance, and “Kocv” represents a variation coefficient used in the delay calculation.

The equation above may be transformed into the following equation:
typ=D/Kocv
Thus, the median value of the delay distribution typ may be obtained by dividing the delay value D by the variation coefficient Kocv. The delay distribution median value typ of the signal provided to the input terminal of the instance corresponds to the delay distribution median value typ_P1 of the signal provided to the terminal P1 of the second FF circuit 66.

As shown in FIG. 10(c), when the median value of the normal distribution is represented by μ, the maximum value is represented by +3σ, and the minimum value is represented by −3σ, the variation value sigma (absolute value) of the maximum value and the minimum value from the distribution median value is represented by the equation:
sigma=+3σ/μ

Accordingly, the delay variation value in the FF circuit 66, that is, the variation value (absolute value) ΔD of the maximum delay value max_P1 and the minimum delay value min_P1 from the delay distribution median value typ_P1 of the signal provided to the terminal P1 is represented by the following equation:
ΔD=typ_{—}P1×sigma

Accordingly, the maximum delay value max_P1 is represented by the equation:
max_{—}P1=typ_{—}P1+ΔD=typ_{—}P1+typ_{—}P1×sigma.
The minimum delay valuemin_P1 is represented by the equation:
min_{—}P1=typ_{—}P1−ΔD=typ_{—}P1−typ_{—}P1×sigma.

The standard deviation 3σ is extracted beforehand and stored in the library. Accordingly, the median value, maximum value, and minimum value of the delay variation distribution in the instances may be calculated by using the analysis result of the static timing analysis (the median value of the delay distribution) and the variation coefficient Kocv representing the OCV coefficient. Thus, there is no need to accumulate delay values of the plurality of instances forming the path. Further, since accumulated values are not used, the conditions for performing the timing analysis may be moderated.

The timing analysis device 11 of the preferred embodiment has the advantages described below.

(1) The timing analysis device 11 executes the static timing analysis (step 23) and extracts a net under relatively strict timing conditions from the analysis result to generate a timing list 37 (step 24). The timing analysis device 11 further executes the delay distribution calculation for the extracted net (step 25a) to analyze the delay variations for each instance. The timing analysis device 11 then retrieves the timing list 37 and calculates the delay distribution by setting a unique delay variation for each instance in the net under relatively strict timing conditions. The timing analysis device 11 then performs the statistical timing analysis based on the calculated delay distribution (step 25b). Accordingly, the timing analysis device 11 executes the statistical timing analysis for the net under relatively strict timing conditions. This prevents the amount of data and the number of analysis operations from being increased and improves the efficiency of the timing analysis. This also improves the timing convergence in a critical path.

(2) The timing analysis device 11 refers to a distribution parameter table indicating distribution of the delay variation amounts to obtain a delay distribution that is in accordance with the input slew rate and the output load capacitance which are set as unique circuit parameters. Further, the timing analysis device 11 sets a unique delay variation for each instance in accordance with a coefficient of fluctuation resulting from the chip layout, such as the layout of each instance and the wiring density around each instance, in order to analyze the distribution parameters related to the element characteristics. The accuracy of the analysis is improved by performing the statistical timing analysis based on the unique delay variation distributions.

(3) The timing analysis device 11 defines a delay value for each instance in accordance with a probability value related to the probability of delay occurrence. In the delay distribution calculation (step 25a), the timing analysis device 11 calculates the median value, the maximum value, and the minimum value of the delay variation distribution of each instance in accordance with the definition. The timing analysis device 11 then performs the statistical timing analysis by using the calculated values. Accordingly, the median value, the maximum value, and the minimum value of the delay variation distribution used for the statistical timing analysis are obtained within a short period of time.

It should be apparent to those skilled in the art that the present invention may be embodied in many other specific forms without departing from the spirit or scope of the invention. Particularly, it should be understood that the present invention may be embodied in the following forms.

In the preferred embodiment, the programs for executing the processing of steps 21 to 26 of FIG. 2 may be provided by a single tool (software). Alternatively, the programs for executing the processing in steps 21 to 26 of FIG. 2 may be provided by separate tools.

In the preferred embodiment, the definition of the delay value may be changed as required.

In the preferred embodiment, the range of the delay distribution is not limited to 3σ. The definition of the delay values may be changed in accordance with the probability value that is used, and may be set to 2σ or 1σ.

The present examples and embodiments are to be considered as illustrative and not restrictive, and the invention is not to be limited to the details given herein, but may be modified within the scope and equivalence of the appended claims.

What is claimed is:

1. A method for analyzing timing of a signal transmitted through a path including one or more instances in a net with the use of a computer, the method comprising:
calculating a delay value for each of the instances;
performing a static timing analysis based on the delay value;
calculating a delay distribution for each of the instances based on the analysis result of the static timing analysis; and
performing a statistical timing analysis based on the analysis result and the delay distribution.

2. The method according to claim 1, further comprising:
extracting a net under relatively strict timing conditions based on the analysis result of the static timing analysis to generate a timing list containing information of the extracted net, wherein:
said calculating a delay distribution includes calculating a delay distribution for each of the instances in the net under the relatively strict timing conditions; and
said performing a statistical timing analysis includes performing an analysis based on the delay distribution calculated for the net under the relatively strict timing conditions and the analysis result of the static timing analysis.

3. The method according to claim 1, wherein said calculating a delay distribution includes calculating the delay distribution based on characteristic information indicating variation characteristics of the delay value, information indicating the calculation result of the delay value, information indicating the analysis result of the static timing analysis, and layout information of the instances.

4. The method according to claim 1, wherein:
said calculating a delay value for each of the instances includes defining the delay value in accordance with a delay occurrence probability value;
said calculating a delay distribution includes calculating a median value, a maximum value, and a minimum value of the delay variation distribution for each of the instances in accordance with the delay value defined for each of the instances; and
performing the statistical timing analysis includes performing the analysis by using the median value, the maximum value, and the minimum value of the delay variation distribution.

5. The method according to claim 4, further comprising:
calculating the delay variation distribution in accordance with a coefficient of fluctuation resulting from chip layout.

6. The method according to claim 5, further comprising:
correcting the delay variation distribution in accordance with a change in one or more variation conditions.

7. A device for analyzing the timing of a signal transmitted through a path including one or more instances in a net, the device comprising:
a delay calculation unit for calculating a delay value for each of the instances;
a first analysis unit for performing a static timing analysis based on the delay value;
a delay distribution calculation unit for calculating a delay distribution for each of the instances based on the analysis result of the static timing analysis; and
a second analysis unit for performing a statistical timing analysis based on the analysis result and the delay distribution.

8. The device according to claim 7, further comprising:
a list generation unit for executing a net under relatively strict timing conditions based on the analysis result of the static timing analysis to generate a timing list containing information of the extracted net, wherein:
the delay distribution calculation unit calculates the delay distribution for each of the instances in the net under the relatively strict timing conditions; and
the second analysis unit performs the statistical timing analysis based on the delay distribution calculated for the net under the relatively strict timing conditions and the analysis result of the static timing analysis.

9. The device according to claim 8, wherein the delay distribution calculation unit calculates the delay distribution based on characteristic information indicating variation characteristics of the delay value, information indicating the calculation result of the delay value, information indicating the analysis result of the static timing analysis, and layout information of the instances.

10. The device according to claim 9, wherein:
the delay calculation unit defines a delay value for each of the instances in accordance with a delay occurrence probability value;
the delay distribution calculation unit calculates a median value, a maximum value, and a minimum value of the delay variation distribution for each of the instances in accordance with the delay value defined for each of the instances; and
the second analysis unit performs the statistical timing analysis by using the median value, the maximum value, and the minimum value of the delay variation distribution.
